(19) United States
(12) Patent Application Publication
(10) Pub. No.: US 2021/0097727 A1
(43) Pub. Date: Apr. 1, 2021

(54) COMPUTER APPARATUS AND METHOD IMPLEMENTING SOUND DETECTION AND RESPONSES THERETO

(71) Applicant: Audio Analytic Ltd, Cambridge (GB)

(72) Inventors: Chris James Mitchell, Cambridge (GB); Sacha Krstulovic, Cambridge (GB); Cagdas Bilen, Cambridge (GB); Neil Cooper, Cambridge (GB); Julian Harris, Cambridge (GB); Arnoldas Jasonas, Cambridge (GB); Joe Patrick Lynas, Cambridge (GB)

(21) Appl. No.: 16/586,050

(22) Filed: Sep. 27, 2019

(51) Int. Cl. G06T 11/00; G10L 25/51; H04N 7/14

(52) U.S. Cl. CPC G06T 11/00; H04N 7/141; G10L 25/51

(57) ABSTRACT

Sound detection and identification leads to responsiveness within an augmented reality environment. Information about an identified sound can be converted into a command for implementation by an augmented reality system, for display of a desired on-screen augmented reality effect.

### FIELD

The present disclosure generally relates to monitoring sound events in a computer monitored environment, and triggering computer implemented actions in response to such sound events.

### BACKGROUND

Background information on sound recognition systems and methods can be found in the applicant's PCT application WO2010/070314, which is hereby incorporated by reference in its entirety.

The present applicant has recognised the potential for new applications of sound recognition systems.

### SUMMARY

In general terms, aspects of the present disclosure concern a computer implementation which is configured to acquire audio data corresponding to a monitoring of a monitored sound environment, and to determine one or more sound events on the audio data, and, on the basis of the one or more sound events, to define a computer implemented process related to the one or more sound events and to initiate that computer implemented process.

The computer implementation may be configured to select a subset of the one or more sound events, from which to define the computer implemented process.

The computer implementation may comprise a computer apparatus, or may comprise a networked plurality of computer apparatuses.

The monitored sound environment may comprise a physical sound environment. Alternatively, or additionally, the monitored sound environment may comprise a virtual sound environment. In a virtual sound environment, sound data may be generated by means of a sound generation computer. Thus, the audio data may be acquired directly from a sound generation computer, without first having being converted into physical acoustic waves.

Aspects of the disclosure provide technology which enables the delivery of an enhanced user experience. In certain aspects of the disclosure, this enhanced user experience comprises better alignment of augmented reality effects with sound events in a monitored sound environment. In an aspect of the disclosure, the monitored sound environment is the user's physical environment. In an aspect of the disclosure, the monitored sound environment comprise an audio channel input to the computer.

In certain aspects of the disclosure, the enhanced user experience comprises presenting augmented reality effects in the form of a graphically displayed object on a user display, the graphically displayed object being selected for alignment with a detected sound event.

An aspect of the disclosure provides a system for implementing a sound-guided augmented reality. In certain embodiments, the system can monitor a sound channel, detect one or more sound events, and modify an augmented reality environment guided by the one or more sound events.

An aspect of the disclosure provides a system and process which effect control or assistance to an augmented reality system as a result of detection (recognition) of one or more identifiable non-verbal sounds.

In an exemplary use case, a system may be responsive to detection of a sound event comprising an animal sound, or an impersonation of an animal sound, by causing an augmented reality system to interact with a video image of a person, by overlaying an animated animal face on the image. The overlay may be conducted for a predetermined period of time after the detection of the sound event.

In another exemplary use case, an augmented reality system may be implemented in a head up display of a vehicle, the head up display being configured to present an image to a user, for instance in a driver line of sight, for instance using a windscreen of the vehicle, or spectacles worn by the user, as an image combiner. In this approach, a system may be responsive to detection of a sound event relevant to road use. For example, a sound of a bicycle bell may be detected and recognised as such. For example, a sound of a siren of an emergency vehicle may be detected and recognised as such. A suitable image object may then be displayed on the head up display, with the intent of conveying to the user graphical information relating to the detected sound event.

For example, it may be preferable also to detect a direction of acquisition of the sound event. On this basis, a localisation estimate of the source of the sound can be obtained. An image presented to the user may be located on the head up display, in a position relating to the direction of the localisation estimate. The image placed in the head up display may comprise information as to the identity and/or direction of arrival of the identified object.

In the above example, the sound detection may be combined with image processing capabilities, to identify an object in the user's view that corresponds to the source of the sound. An image placed in the head up display may correspond to the object identified in the user's view. The image placed in the head up display may be such as to draw the user's attention to the identified object. In one example, an image of a ring, circle or other outline effect may be superimposed on an image presented to a user, aligned with the view of the object identified as the source of the detected sound event, so as to draw the attention of the user to the existence of the identified object.

This can have an impact on driving safety—if a system detects a sound event which can be identified as corresponding to, for instance, a bicycle or an emergency vehicle, the driver's attention can be drawn to the existence of the object. The system can present information in a head up display to a driver, even before the source of the sound event is in view. So, for instance, the sound of a siren of an emergency vehicle may be detectable long before the emergency vehicle is in view. A system in accordance with an aspect disclosed herein may provide information to a driver which enables localisation of an emergency vehicle, in advance of the vehicle being visible in the driver's line of sight.

Further, it is possible that a bicycle is beyond the field of vision of a driver. Commonly, road traffic accidents occur due to bicycles being positioned in a driver's so-called blind spot—i.e. at an angle with respect to the driver's field of vision that renders the bicycle unviewable even with the aid of mirrors provided for the driver's use. By using a system in accordance with an aspect of the present disclosure, a warning can be presented to a driver corresponding to detection of a sound event corresponding to a bicycle bell, a warning shout by a rider, or, for instance, a sound of bicycle brakes being deployed. The warning may present localisation information to the driver. The warning may comprise a sign, a message or other graphical feature intended to convey to the driver the proximity of the bicycle. The sign, message or other graphical feature may convey to the driver a measure of the proximity of the bicycle. The sign, message or graphical feature may convey information to the driver as to a direction from which the sound event was acquired, so as to enable the driver to discern a position estimate of the bicycle with respect to the driver.

In the context of video telecommunication, a technical improvement to a user experience may be obtained by providing augmented reality effects in response to detection and identification of non-verbal sounds.

Aspects disclosed herein may further provide advantages in the field of entertainment and consumer information. So, for instance, an action in an augmented reality environment may be triggered upon detection of a sound event, the action being associated with an identity attributed to the sound event. To provide a concrete example of this, it would be possible to detect a sound event corresponding to the sound of a bottle of beer being opened. In response, an augmented reality system may provide a graphical image to the user corresponding to that event. The graphical image may, for example, be a commercial advertising presentation concerning a particular type or brand of beer. Using detection and image processing, the augmented reality system may respond to the sound event by seeking to identify, in the field of view, the source of the sound event. The system may derive further information concerning the source of the sound event, to further align the augmented reality event with the sound event. So, for instance, using the same example, if the sound event comprises the sound of a bottle of beer being opened, and the augmented reality system is then able to identify a beer bottle in the field of view which may be the source of the sound event, by image processing the augmented realty system may, for instance, overlay an advertisement in the augmented reality environment to align with the image of the real beer bottle. Further, by image processing, the system may identify further information about the beer bottle, such as a brand or type. The graphical image may comprise information about the beer, based on further information derived by image processing.

In general terms, an aspect of the present disclosure comprise a computer system able to recognise non-verbal sounds and to control or to aid an augmented reality system as a result of recognising the presence or the direction of arrival of the recognised sounds.

In one embodiment, the computer system comprises three subsystems:
a sound recognition block, able to recognise the presence and, optionally, direction of arrival of non-vocal sounds from digitized audio;
an augmented reality (AR) system able to detect visual features from pictures or video feeds and to overlay computer graphics at particular locations of the images
a model designed to associate the presence of non-verbal sounds and their direction of arrival with particular effects or events within the AR system, such as:
   to start/stop the AR based on the recognition of certain sounds, for example start an AR video overlay if the sound of opening a consumer product is recognised,
   choose the right type of AR, for example associate the recognition of a real or imitated animal sound with corresponding animal graphics that can be overlaid on human faces in a video,
   assist image recognition which underlies AR by biasing video detection to actively search for certain objects in the image, for example more actively seek to recognise a bicycle into the video if the sound of a bicycle is identified in the audio, or to look for objects in particular portions of the image, for example seeking a bicycle in a particular part of an image if a sound event associated with a bicycle emanates from that direction.

It will be appreciated that the functionality of the devices described herein may be divided across several modules. Alternatively, the functionality may be provided in a single module or a processor. The or each processor may be implemented in any known suitable hardware such as a microprocessor, a Digital Signal Processing (DSP) chip, an Application Specific Integrated Circuit (ASIC), Field Programmable Gate Arrays (FPGAs), GPU (Graphical Processing Unit), TPU (Tensor Processing Unit) or NPU (Neural Processing Unit) etc. The or each processor may include one or more processing cores with each core configured to perform independently. The or each processor may have connectivity to a bus to execute instructions and process information stored in, for example, a memory.

The invention further provides processor control code to implement the above-described systems and methods, for example on a general purpose computer system or on a digital signal processor (DSP) or on a specially designed math acceleration unit such as a Graphical Processing Unit (GPU) or a Tensor Processing Unit (TPU). The invention also provides a carrier carrying processor control code to, when running, implement any of the above methods, in particular on a non-transitory data carrier—such as a disk, microprocessor, CD- or DVD-ROM, programmed memory such as read-only memory (Firmware), or on a data carrier such as an optical or electrical signal carrier. The code may be provided on a carrier such as a disk, a microprocessor, CD- or DVD-ROM, programmed memory such as non-volatile memory (e.g. Flash) or read-only memory (Firmware). Code (and/or data) to implement embodiments of the invention may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate such code and/or data may be distributed between a plurality of coupled components in communication with one another. The invention may comprise a controller which includes a microprocessor, working memory and program memory coupled to one or more of the components of the system.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 shows a block diagram of example devices in a monitored environment;

FIG. 2 shows a block diagram of a computing device;

FIG. 3 shows a block diagram of software implemented on the computing device;

FIG. 4 is a flow chart illustrating a process of providing an augmented reality environment according to an embodiment;

FIG. 5 is a process architecture diagram illustrating a first implementation of an embodiment and indicating function and structure of such an implementation;

FIG. 6 is a process architecture diagram illustrating a second implementation of an embodiment and indicating function and structure of such an implementation.

### DETAILED DESCRIPTION

Embodiments will now be described by way of example only.

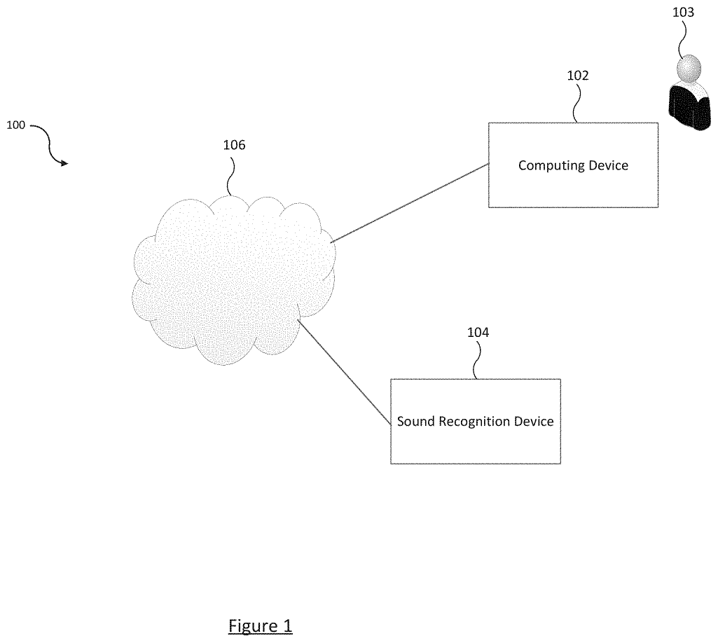

FIG. 1 shows a computing device 102 in a monitored environment 100 which may be an indoor space (e.g. a house, a gym, a shop, a railway station etc.), an outdoor space or in a vehicle. The computing device 102 is associated with a user 103.

The network 106 may be a wireless network, a wired network or may comprise a combination of wired and wireless connections between the devices.

As described in more detail below, the computing device 102 may perform audio processing to recognise, i.e. detect, a target sound in the monitored environment 100. In alternative embodiments, a sound recognition device 104 that is external to the computing device 102 may perform the audio processing to recognise a target sound in the monitored environment 100 and then alert the computing device 102 that a target sound has been detected.

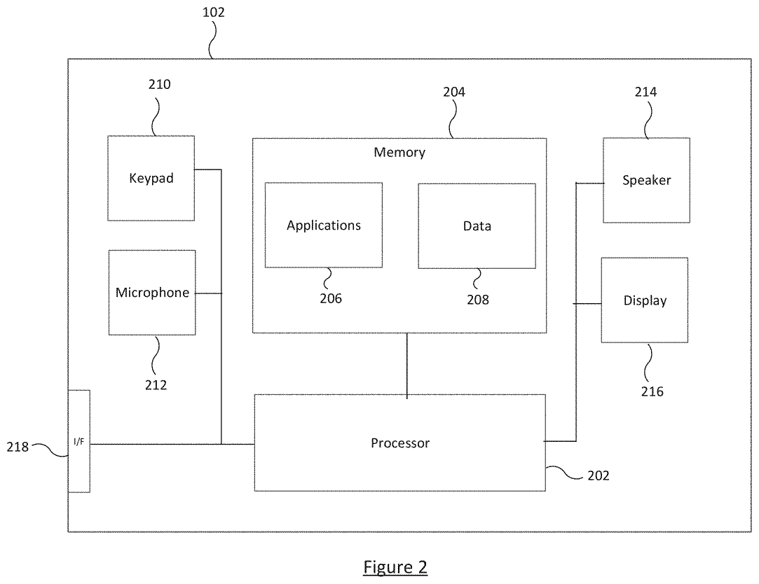

FIG. 2 shows a block diagram of the computing device 102. It will be appreciated from the below that FIG. 2 is merely illustrative and the computing device 102 of embodiments of the present disclosure may not comprise all of the components shown in FIG. 2.

The computing device 102 may be a PC, a mobile computing device such as a laptop, smartphone, tablet-PC, a consumer electronics device (e.g. a smart speaker, TV, headphones, wearable device etc.), or other electronics device (e.g. an in-vehicle device). The computing device 102 may be a mobile device such that the user 103 can move the computing device 102 around the monitored environment. Alternatively, the computing device 102 may be fixed at a location in the monitored environment (e.g. a panel mounted to a wall of a home). Alternatively, the device may be worn by the user by attachment to or sitting on a body part or by attachment to a piece of garment.

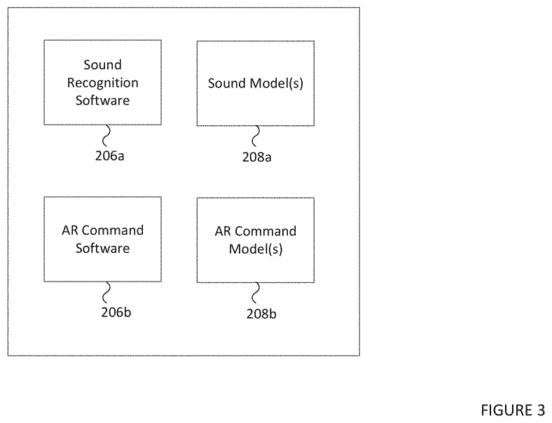

The computing device 102 comprises a processor 202 coupled to memory 204 storing computer program code of application software 206 operable with data elements 208. As shown in FIG. 3, a map of the memory in use is illustrated. A sound recognition process 206a is used to recognise a target sound, by comparing detected sounds to one or more sound models 208a stored in the memory 204. The sound model(s) 208a may be associated with one or more target sounds (which may be for example, a bicycle bell sound, a screeching brake sound, a siren sound, an animal sound (real or impersonated), a bottle opening sound, and so on).

An augmented reality process 206b is operable with reference to augmented reality data 208b on the basis of a detected sound event by the sound recognition process 206a. The augmented reality process 206b is operable to trigger, on the basis of a detected sound event, presentation of an augmented reality event to a user, by visual output.

The computing device 102 may comprise one or more input devices e.g. physical buttons (including single button, keypad or keyboard) or physical control (including rotary knob or dial, scroll wheel or touch strip) 210 and/or microphone 212. The computing device 102 may comprise one or more output device e.g. speaker 214 and/or display 216. It will be appreciated that the display 216 may be a touch sensitive display and thus act as an input device.

The computing device 102 may also comprise a communications interface 218 for communicating with the sound recognition device. The communications interface 218 may comprise a wired interface and/or a wireless interface.

As shown in FIG. 3, the computing device 102 may store the sound models locally (in memory 204) and so does not need to be in constant communication with any remote system in order to identify a captured sound. Alternatively, the storage of the sound model(s) 208 is on a remote server (not shown in FIG. 2) coupled to the computing device 102, and sound recognition software 206 on the remote server is used to perform the processing of audio received from the computing device 102 to recognise that a sound captured by the computing device 102 corresponds to a target sound. This advantageously reduces the processing performed on the computing device 102.

### Sound Model and Identification of Target Sounds

A sound model 208 associated with an identifiable non-verbal sound is generated based on processing a captured sound corresponding to the target sound class. Preferably, multiple instances of the same sound are captured more than once in order to improve the reliability of the sound model generated of the captured sound class.

In order to generate a sound model the captured sound class(es) are processed and parameters are generated for the specific captured sound class. The generated sound model comprises these generated parameters and other data which can be used to characterise the captured sound class.

There are a number of ways a sound model associated with a target sound class can be generated. The sound model for a captured sound may be generated using machine learning techniques or predictive modelling techniques such as: hidden Markov model, neural networks, support vector machine (SVM), decision tree learning, etc.

The applicant's PCT application WO2010/070314, which is incorporated by reference in its entirety, describes in detail various methods to identify sounds. Broadly speaking an input sample sound is processed by decomposition into frequency bands, and optionally de-correlated, for example, using PCA/ICA, and then this data is compared to one or more Markov models to generate log likelihood ratio (LLR) data for the input sound to be identified. A (hard) confidence threshold may then be employed to determine whether or not a sound has been identified; if a “fit” is detected to two or more stored Markov models then preferably the system picks the most probable. A sound is “fitted” to a model by effectively comparing the sound to be identified with expected frequency domain data predicted by the Markov model. False positives are reduced by correcting/updating means and variances in the model based on interference (which includes background) noise.

It will be appreciated that other techniques than those described herein may be employed to create a sound model.

The sound recognition system may work with compressed audio or uncompressed audio. For example, the time-frequency matrix for a 44.1 KHz signal might be a 1024 point FFT with a 512 overlap. This is approximately a 20 milliseconds window with 10 millisecond overlap. The resulting 512 frequency bins are then grouped into sub bands, or example quarter-octave ranging between 62.5 to 8000 Hz giving 30 sub-bands.

A lookup table can be used to map from the compressed or uncompressed frequency bands to the new sub-band representation bands. For the sample rate and STFT size example given the array might comprise of a (Bin size÷2)×6 array for each sampling-rate/bin number pair supported. The rows correspond to the bin number (centre)—STFT size or number of frequency coefficients. The first two columns determine the lower and upper quarter octave bin index numbers. The following four columns determine the proportion of the bins magnitude that should be placed in the corresponding quarter octave bin starting from the lower quarter octave defined in the first column to the upper quarter octave bin defined in the second column. e.g. if the bin overlaps two quarter octave ranges the 3 and 4 columns will have proportional values that sum to 1 and the 5 and 6 columns will have zeros. If a bin overlaps more than one sub-band more columns will have proportional magnitude values. This example models the critical bands in the human auditory system. This reduced time/frequency representation is then processed by the normalisation method outlined. This process is repeated for all frames incrementally moving the frame position by a hop size of 10 ms. The overlapping window (hop size not equal to window size) improves the time-resolution of the system. This is taken as an adequate representation of the frequencies of the signal which can be used to summarise the perceptual characteristics of the sound. The normalisation stage then takes each frame in the sub-band decomposition and divides by the square root of the average power in each sub-band. The average is calculated as the total power in all frequency bands divided by the number of frequency bands. This normalised time frequency matrix is the passed to the next section of the system where a sound recognition model and its parameters can be generated to fully characterise the sound's frequency distribution and temporal trends.

The next stage of the sound characterisation requires further definitions.

A machine learning model is used to define and obtain the trainable parameters needed to recognise sounds. Such a model is defined by:
a set of trainable parameters θ, for example, but not limited to, means, variances and transitions for a hidden Markov model (HMM), support vectors for a support vector machine (SVM), weights, biases and activation functions for a deep neural network (DNN),
a data set with audio observations o and associated sound labels l, for example a set of audio recordings which capture a set of target sounds of interest for recognition such as, e.g., baby cries, dog barks or smoke alarms, as well as other background sounds which are not the target sounds to be recognised and which may be adversely recognised as the target sounds. This data set of audio observations is associated with a set of labels l which indicate the locations of the target sounds of interest, for example the times and durations where the baby cry sounds are happening amongst the audio observations o.

Generating the model parameters is a matter of defining and minimising a loss function L(θ|o, l) across the set of audio observations, where the minimisation is performed by means of a training method, for example, but not limited to, the Baum-Welsh algorithm for HMMs, soft margin minimisation for SVMs or stochastic gradient descent for DNNs.

To classify new sounds, an inference algorithm uses the model to determine a probability or a score P(C|o, θ) that new incoming audio observations o are affiliated with one or several sound classes C according to the model and its parameters θ. Then the probabilities or scores are transformed into discrete sound class symbols by a decision method such as, for example but not limited to, thresholding or dynamic programming.

The models will operate in many different acoustic conditions and as it is practically restrictive to present examples that are representative of all the acoustic conditions the system will come in contact with, internal adjustment of the models will be performed to enable the system to operate in all these different acoustic conditions. Many different methods can be used for this update. For example, the method may comprise taking an average value for the sub-bands, e.g. the quarter octave frequency values for the last T number of seconds. These averages are added to the model values to update the internal model of the sound in that acoustic environment.

In embodiments whereby the computing device 102 performs audio processing to recognise a target sound in the monitored environment 100, this audio processing comprises the microphone 212 of the computing device 102 capturing a sound, and the sound recognition 206a analysing this captured sound. In particular, the sound recognition 206a compares the captured sound to the one or more sound models 208a stored in memory 204. If the captured sound matches with the stored sound models, then the sound is identified as the target sound.

On the basis of the identification of a target sound, or a recognised sequence of target sounds, indicative of the presence of a target, a signal is sent from the sound recognition process to the augmented reality control system bearing information defining the sound event.

So, also stored in memory is AR command software 206b, implementing the augmented reality control system, to enable responses to identified sound events to be converted into AR effects. Suitable responses are stored as AR Command models 208b which provide correspondence between anticipated sound events and suitable AR effects. These correspondences may be developed by human input action, or by further machine learning techniques similar to those related above.

In this disclosure, target sounds of interest are non-verbal sounds. A number of use cases will be described in due course, but the reader will appreciate that a variety of non-verbal sounds could operate as triggers for presence detection. The present disclosure, and the particular choice of examples employed herein, should not be read as a limitation on the scope of applicability of the underlying concepts.

### Process

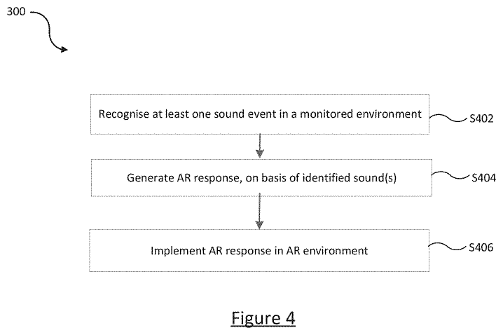

An overview of a method implementing the specific embodiment will now be described with reference to FIG. 4. As shown in FIG. 4, the process has three fundamental stages. In a first stage S402, sound events are detected and identified on a received audio channel. Then, AR commands are generated in response to sound events, in step S404. Finally, the AR commands are implemented, in step S404, on an AR system.

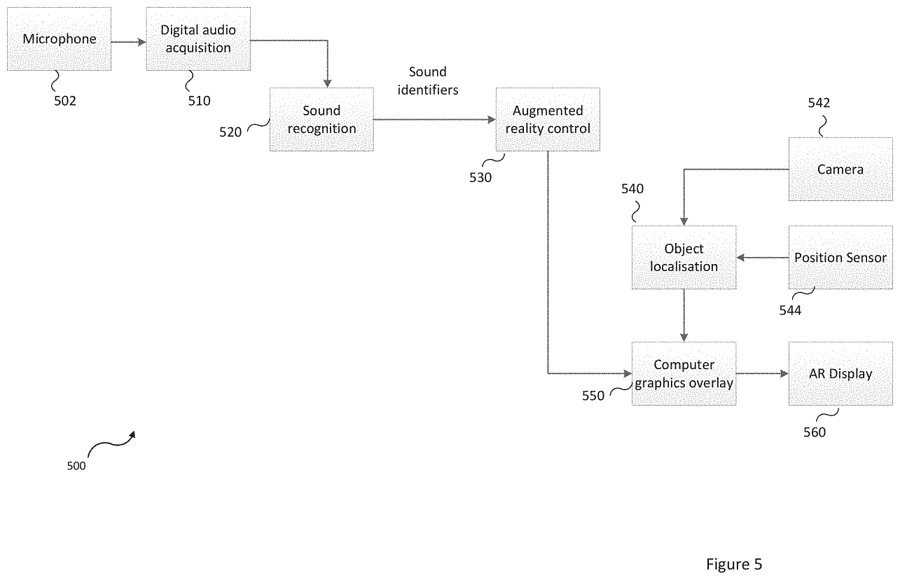

As shown in FIG. 5, a system 500 implements the above method in a number of stages.

Firstly, a microphone 502 is provided to monitor sound in the location of interest.

Then, a digital audio acquisition stage 510, implemented at the sound recognition computer, continuously transforms the audio captured through the microphone into a stream of digital audio samples.

A sound recognition stage 520 comprises the sound recognition computer continuously running a programme to recognise non-verbal sounds from the incoming stream of digital audio samples, thus producing a sequence of identifiers for the recognised non-verbal sounds. This can be done with reference to sound models 208a as previously illustrated.

The sequence of identifiers thus comprises a series of data items, each providing information identifying the nature of a sound event with respect to the sound models, such as descriptive information, which may be conveyed in any pre-determined format. Alongside the descriptive information, conveying the type of sound, the sound event information may also comprise timing information, such as the time of commencement of detection of a sound and/or the time of cessation of detection of a sound.

The recipient of the sequence of identifiers is an augmented reality control stage 530. The augmented reality control stage 530 is configured to provide one or more responses to receipt of one or more items of sound event information. A response to a particular sound event may be pre-determined. These responses may be determined in relation to augmented reality response models 208b as previously described.

Control commands, issued by the augmented reality control stage 530, are conveyed to a computer graphics overlay stage 550, which is further in receipt of object localisation information generated by an object localisation stage 540. The object localisation stage 540, with the aid of a camera 542 and a position sensor 544, provides information to the overlay stage 550 to enable the overlay stage 550 to integrate augmented reality effects into an image comprising a combination of a first display to the user (which may be a real view captured at the camera) together with augmented reality effects. This combined image is displayed at an AR display, which may be on goggles, spectacles, or an image combiner such as a head up display (e.g. a windscreen or the like).

Two examples of use of the system will now be described.

In a first implementation, the system is used in the conduct of a video telecommunication session—a video call. In the following description, at least one of the users of the video call presents a camera image to the other user.

When one or other user, during the call, makes a non-verbal utterance which the sound recognition stage 520 can identify, it sends sound event information to the augmented reality control stage 530. Taking, for example, the scenario where one or other user makes a noise impersonating an animal, such as the “moo” of a cow, then the augmented reality control stage 530 responds to the sound event “cow mooing” by commanding that the computer graphics overlay stage 550 overlays an image, which may be a caricatured image, of a cow's head over the image, on-screen, of the user. This is achieved by the image from the camera 542 (which, in this embodiment, is at the first user and remote from the second user, seeing the final image) and the position sensor 544, enabling the object localisation stage 540 identifying the position of the user's head on-screen and sending requisite position information to the computer graphics overlay unit 550.

The result of this is to place the final combined image at the AR display 560.

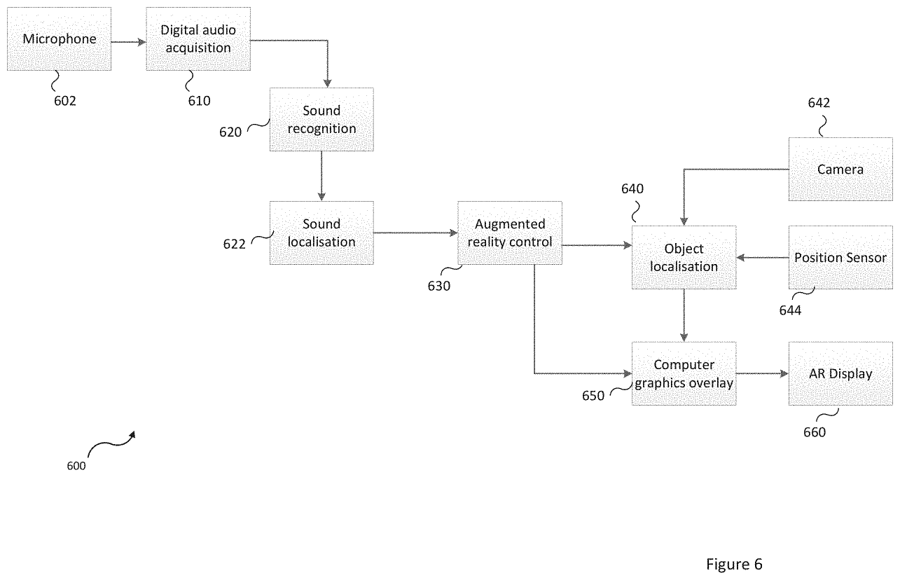

A second implementation takes advantage of a further feature, described and illustrated in FIG. 6. As will be seen in FIG. 6, there are many similarities to the embodiment shown in FIG. 5. For this reason, reference numerals are provided with substantial correspondence between both figures, except for prefix ‘6’ instead of ‘5’.

The additional feature is that of a sound localisation stage 622. This takes the sound identifiers produced by the sound recognition stage 620 and adds further localisation information, comprising a measure or estimate of the direction of arrival of each identified sound event. This information is then passed to the augmented reality control stage 630.

As before, the augmented reality control stage 630 is triggered then to produce a control command to the computer graphics overlay stage 650 to produce an AR effect. However, in this case, the augmented reality control stage 630 is operable to produce other commands, depending on implementation.

For example the augmented reality control stage 630 may issue a localisation command to the object localisation stage 640, indicating a direction of a source of a sound event and thus guidance to the object localisation stage 640 as to the possible objects in the field of vision that may be identified as the source of the sound.

For further example, the augmented reality control stage 630 may issue an attention command to the object localisation stage 640, seeking that the object localisation stage 640 carry out a task in response to the identification of a sound. This may be particular important, in an implementation involving safety of individuals, so a command could for instance be issued that the object localisation stage 640 should find a bicycle in the field of view of the camera 642.

So, in the context of this, a second example implementation involves production of a head up display in a motor vehicle. Such head up displays may show the speed of travel, simple navigation instructions, and warnings concerning the vehicle's performance.

In this example, it is envisaged that the sound recognition stage 620 is capable of identifying sound events comprising commencement and cessation of a bicycle bell being sounded. The augmented reality control stage 630 is configured to respond to this, to cause an alert message to be placed on the head up display. The alert message, in this case, consists also of location information derived from the sound localisation stage 622. So, in this instance, if a bicycle bell sound is detected and identified, and the localisation of that bell sound is determined to be, for example, to the rear and the left of the driver, then the indication on the head up display will indicate this.

All of this can be achieved without user input. The above embodiments may provide improvements in the manner in which an AR system responds, automatically, to sound events in the environment to which the AR system applies. These responses can be aesthetic or informational, depending on the context in which the system is implemented. In some embodiments, localisation can provide further advantages in the way in which AR is affected.

Embodiments described herein couple a machine learning approach to sound recognition, with incorporation of decision-making, which can incorporate further machine learning techniques, to provide a system for implementing an augmented reality output to a user which provides potentially greater alignment to the audible environment, either physical or virtual (or both).

1. A computer system for implementing an augmented reality environment, the computer system comprising:
a sound acquirer for acquiring audio data;
a sound processor for recognizing a non-verbal sound event by processing the audio data using one or more sound models to obtain a non-verbal sound event identifier for the non-verbal sound event;
an augmented reality controller for determining and generating an augmented reality effect command by: inputting at least the non-verbal sound event identifier into an augmented reality effect command model; and receiving the augmented reality effect command from the augmented reality effect command model; and
an augmented reality environment generator for generating an augmented reality graphical data output by implementing the augmented reality effect command.

2. A computer system in accordance with claim 1 wherein implementing the augmented reality effect command comprises overlaying a graphical symbol corresponding to the non-verbal sound event identifier over a portion of an image in the augmented reality environment.

3. A computer system in accordance with claim 2 and further comprising an image localisation stage operable to identify a position of an object in the image and on the basis of which to place the overlay.

4. A computer system in accordance with claim 1 and further implemented to establish a video telephonic session, the video telephonic session causing the generation of an image of a scene at one use point of the video telephonic session, and wherein the augmented reality controller is operable to generate an augmented reality effect in the image of the scene of the use point.

5. A computer system in accordance with claim 1 wherein the sound processor is operable to determine a sound event identity on the basis of comparison with the one or more sound models.

6. A computer system in accordance with claim 1 and further comprising a sound localisation processor for processing the audio data to obtain a sound event location identifier, corresponding to the non-verbal sound event identifier, indicating a direction of receipt of the acquired audio data.

7. A computer system in accordance with claim 3 wherein the augmented reality environment generator is operable to generate an augmented reality graphical data output based on the a direction of receipt of the non verbal sound audio data.

8. A computer system in accordance with claim 4 wherein the augmented reality environment generator is operable to generate an augmented reality graphical data output comprising an augmented reality effect in a position in the augmented reality environment based on a direction of receipt of the audio data.

9. A computer system in accordance with claim 1 wherein the augmented reality controller is operable to determine an augmented reality effect with reference to one or more augmented reality effect models, the augmented reality effect being determined on the basis of comparison with the one or more augmented reality effect models.

10. A computer system in accordance with claim 1 wherein the augmented reality effect command has a semantic correspondence with the non-verbal sound event identifier.

11. A method of implementing an augmented reality environment, comprising:
acquiring audio data;
processing the audio data using one or more sound models to obtain a non-verbal sound event identifier for the non-verbal sound event;
determining and generating an augmented reality effect command by: inputting at least the non-verbal sound event identifier into an augmented reality effect command model; and receiving the augmented reality effect command from the augmented reality effect command model; and
generating an augmented reality graphical data output by implementing the augmented reality effect command.

12. A non-transitory storage medium storing computer executable instructions which, when executed by a computer, cause the computer to perform a method in accordance with claim 11.

13. A computer system in accordance with claim 1, wherein the augmented reality effect command model comprises a machine learned model.

14. A computer system in accordance with claim 1, wherein the sound acquirer is configured to acquire the audio data from a sound generation module.

15. A computer system in accordance with claim 14, wherein the computer system comprises the sound generation module and the sound generation module is configured to generate a sound for a virtual sound environment.

16. A computer system in accordance with claim 1, wherein the sound acquirer is configured to acquire the audio data from audio captured by a microphone.
